(19) United States
(12) Patent Application Publication
(10) Pub. No.: US 2025/0216350 A1
(43) Pub. Date: Jul. 3, 2025

(54) COATED VESSELS FOR WATER CALORIMETRY

(71) Applicant: SUNNYBROOK RESEARCH INSTITUTE, Toronto (CA)

(72) Inventors: Arman Sarfehnia, Toronto (CA); Mark D'Souza, Toronto (CA)

(21) Appl. No.: 19/000,087

(22) Filed: Dec. 23, 2024

Related U.S. Application Data
(60) Provisional application No. 63/617,231, filed on Jan. 3, 2024.

(30) Foreign Application Priority Data
May 16, 2024 (CA) 3238529

(51) Int. Cl. G01N 25/48

(52) U.S. Cl. CPC G01N 25/4886

(57) ABSTRACT

Disclosed herein are internally coated vessels for use in water calorimetry to replace traditional glass vessels. The vessels internally coated with one or more polymer layers selected to prevent impurities diffusing into the water from both the material of which the vessel is made and the one or more layers themselves during water calorimetry measurements.

### FIELD

The present disclosure relates to vessels, more particularly coated vessels, for use in water calorimetry applications.

### BACKGROUND

Absorbed dose to water (defined as the amount of radiation energy absorbed per unit mass) is the quantity of interest in radiation therapy. In the clinic, reference dose is measured by utilizing a reference-class radiation dosimeter, commonly an ionization chamber, calibrated at a national primary standard dosimetry laboratory (PSDL). All reference dose measurements are performed under well-defined reference conditions outlined by international codes of practice.

In water calorimetry, absolute dose to water is determined directly by measuring the radiation-induced temperature rise. This technique allows for the most direct means of measuring absorbed dose to water at a point in radiation dosimetry, and as such is commonly used at PSDL as an absolute dosimeter. Ideally, all the energy deposited by ionizing radiation and absorbed by the medium is directly converted to heat; however, free radicals that are produced can react with impurities present in water leading to endo/exothermic reactions that can cause additional heat loss/gain, referred to as heat defect. To minimize heat defect, thermistors, temperature sensors of choice in water calorimetry, are sealed within a small vessel that is filled with high-purity water and subsequently saturated with a known high-purity gas to remove trace amounts of dissolved gas molecules; This procedure is undertaken as it is much easier to control the purity of water in a small volume vessel than a large water calorimeter tank.

Although a few early calorimeters made use of Lucite® plastic vessels, it was quickly discovered that in such cases the water calorimeter response was unstable and would change as a function of time and accumulated dose (ref. 1). Over time, the calorimeters' response increased, but after receiving a large dose, the response would return to a steady state before increasing again (ref. 1).

This behavior was associated with organic molecules from the vessel material leaching into water that would then act as impurities and cause a gradual increase in exothermic response. However, after large irradiations, the concentration of these impurities would drop as they were ‘used up’, returning the calorimeter to a steady state. To avoid an unstable response, modern calorimeters employ inert borosilicate-based glass vessels (FIG. 1), as this material is chemically stable and has been proven not to leach into water over time. This results in a heat defect that has been shown to be stable and can thus be characterized, albeit it is a function of linear energy transfer (LET) of the ionizing particles as well as the saturating gas (refs. 2, 3). These vessels are fragile, expensive, and hand-crafted by a handful of expert glass-blowers worldwide.

In recent years, the introduction and adoption of novel radiotherapy techniques and equipment have significantly transformed the field. This includes the utilization of complex treatment methods such as Intensity Modulated Radiation Therapy (IMRT) and Volumetric Modulated Arc Therapy (VMAT), along with highly specialized delivery units like Cyberknife, MR-integrated linear accelerators (linacs), and Gamma Knife ICON. These innovative approaches often lead to non-compliant beams, as they differ markedly from conventional treatments and cannot meet the basic reference conditions demanded by existing protocols. In clinics, to measure absorbed dose for these units, often calculated or experimentally derived correction factors are applied to existing formalisms to account for either non-compliance of the radiation beam/setup (relative to reference conditions defined by existing protocols) or to correct for ionization chamber response changes in these non-reference conditions. Given that water calorimetry is theoretically independent of radiation beam quality, the delivery technology, the reference conditions, etc., its use in such modern delivery technologies allows for accurate radiation dose measurement and proper ionization chamber characterization.

### SUMMARY

An objective of the present disclosure is to detail a methodology to produce vessels appropriate for use in water calorimetry that are not necessarily handcrafted from glass. All prior literature has focused on inert borosilicate-based glass as the main viable material for water calorimetry vessel construction. It is shown in this disclosure that material of the vessel may play a minimal role in its choice if modern surface coating techniques are employed.

In an embodiment, the present disclosure provides a water calorimeter vessel, comprising a vessel having a preselected size, shape and internal volume enclosed by an inner wall with the vessel being at least partially transparent to radiation. The vessel has one or more coated layers on the internal wall of the vessel with the one or more layers selected on the basis of being able to block impurities/leachants diffusing from material from which the vessel is made and from the one or more layers into the interior of the vessel. The vessel also includes one or more temperature sensors are located on the interior of the vessel and are connected to a temperature recording device.

The one or more coated layers on the internal wall may be an organic material or an inorganic material. The organic material is any one or combination of Parylene N, Parylene C, Parylene D, Parylene HT and Parylene AF-4. The inorganic material may be any one or combination of titanium, gold, aluminum, copper, or glass. The one or more coatings may be any material that acts as a barrier to impurities or leachants diffusing from the material the vessel is made of. The coating itself needs to be chemically inert in the presence of water and should not result in large radiation-induced chemical reactions.

The water calorimeter vessel may be made from any one of a polymer, graphite, aluminum, other metals or alloys, ceramics, synthetic materials, aerogel or aerogel-based materials or other composites. The polymer may be any one of acrylic, polyethylene, vinyl, polystyrene, nylon or Delrin.

The vessel may be 3D printed using a resin of the polymer. It will be understood that vessel may be made of anything that can be produced with high accuracy and reproducibility, and preferably that can be produced rapidly with high accuracy, while being partially transparent to radiation. The material used to make the vessel may have a specific heat capacity, thermal conductivity, and density within 60% of water.

The water calorimeter vessel contains one or more thermistors that are connected to electronics for readout. The vessel may contain structures that act as convective barriers, or baffles to reduce convective current around the interior and/or exterior of the vessel.

The one or more layers coating the internal surface of the vessel may have an accumulated thickness greater than about 1 micrometer. The vessel surface through which radiation passes may have a thickness in a range from about 0.20 to 1.50 millimeters.

A further understanding of the functional and advantageous aspects of the disclosure can be realized by reference to the following detailed description and drawings.

### BRIEF DESCRIPTION OF THE DRAWINGS

The following is a description, by way of example only, of a method and system to produce vessels for water calorimetry that minimize heat defect in accordance with the present disclosure, reference being had to the accompanying drawings, in which:

FIG. 1 is a photograph of a plane parallel glass vessel used for calorimetry inside the calorimeter. The thermistor is embedded at the very tip of a thin pipette needle structure that can be seen inside the vessel.

FIG. 2 is a photograph of a glass Vessel [top] and an Accura ClearVue 3D-printed vessel [bottom].

FIG. 3 shows the repeating structure of A) Parylene N and, B) Parylene C (Image curtesy of SCS systems (ref. 13)).

FIG. 4 is a plot of heat defect vs vessel type showing heat defect correction for uncoated Accura ClearVue vessels, and Parylene C coated vessels.

FIG. 5A shows a plot of heat defect vs vessel/setup number showing heat defects of 4 Parylene N coated vessels for 6 MV FFF and 18 MV radiation beams. A setup refers to a completely independent measurement session that includes full preparation of the vessel from scratch (new water fill, saturation, distance measurements, etc.). The dotted box shows the combined average data from a long-term study.

FIG. 5B shows the individual data points from a long-term study that shows heat defect vs time/accumulated dose for a Parylene N coated vessel that was sealed inside a water calorimeter. Bottom axis shows time sealed in days while top axis shows accumulated dose in Gy.

FIG. 6A shows a transmission electron microscope (TEM) image at 5300× magnification of an uncoated Accura ClearVue vessel.

FIG. 6B shows a transmission electron microscope (TEM) image at 5300× magnification of a used Parylene N coated vessel. The Parylene N coated vessel has a ˜3 μm thick uniform coating.

FIG. 7A shows a 3D rendering of an alternative water calorimeter vessel design with interior structures acting as convective barriers and pathways for thermistors.

FIG. 7B shows a cross-section of yet another alternative water calorimeter vessel design.

### DETAILED DESCRIPTION

Various embodiments of vessels for use in water calorimetry applications will be described with reference to details discussed below. The following description and drawings are illustrative of the disclosure and are not to be construed as limiting the disclosure. The Figures are not to scale. Numerous specific details are described to provide a thorough understanding of various embodiments of the present disclosure. However, in certain instances, well-known or conventional details are not described in order to provide a concise discussion of embodiments of the present disclosure.

As used herein, the terms “comprises” and “comprising” are to be construed as being inclusive and open ended, and not exclusive. Specifically, when used in the specification and claims, the terms “comprises” and “comprising” and variations thereof mean the specified features, steps or components are included. These terms are not to be interpreted to exclude the presence of other features, steps or components.

As used herein, the term “exemplary” means “serving as an example, instance, or illustration,” and should not be construed as preferred or advantageous over other configurations disclosed herein.

As used herein, the terms “about” and “approximately” are meant to cover variations that may exist in the upper and lower limits of the ranges of values, such as variations in properties, parameters, and dimensions.

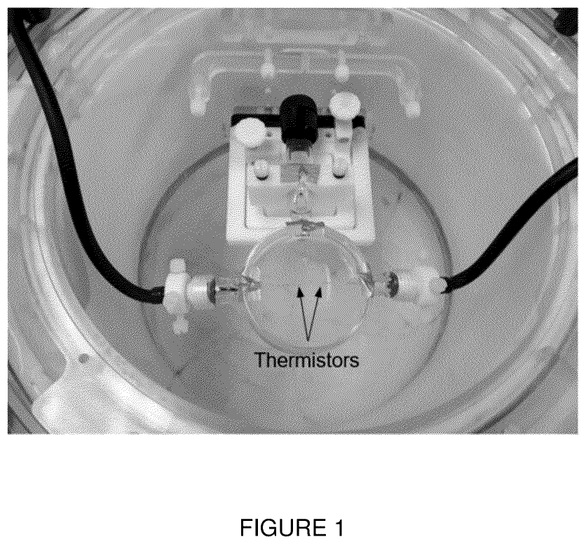

For the past several decades, the inventors and associates have been involved in designing and building unique water calorimeters that have been used for absolute dosimetry in HDR Ir-192 brachytherapy (refs. 4, 5), high energy electron beams (ref. 6), proton beams (refs. 7-9) and MR-integrated linear accelerators (refs. 10, 11). To date water calorimetry has not been used in several modern radiation delivery technologies such as Cyberknife®, GammaKnife® ICON™, or volumetric modulated arc therapy VMAT delivery methods. One obstacle in water calorimetry relates to be the complexities associated with the construction and use of the glass vessel, as these artifacts are crafted by hand and as such cannot always be made precisely to prescribed dimensions, many shapes/designs are simply not feasible, are often back-ordered and may cost upwards of ten thousand dollars. As a result, glass vessels used often have simple shapes, such as a parallel plane vessel (FIG. 1) or a cylindrical vessel, limiting their use in complex modalities where other shapes/designs may be advantageous (e.g., a spherical vessel in GammaKnife® ICON or specialized vessel designs for HDR Ir-192 brachytherapy as described by Sarfehnia (ref. 12).

The present disclosure will be illustrated using a non-limiting and exemplary example of producing a water calorimeter using stereolithography (SLA) 3D-printing techniques, combined with a polymer coating, to create cost-effective and precision-engineered vessels suitable for water calorimetry. This approach allows for the production of vessels that can be uniquely tailored to specific modalities. This can potentially increase the accessibility of water calorimeters in modern radiation delivery modalities and techniques. However, to successfully use SLA materials, their heat defects must be thoroughly investigated to determine if their use results in a stable, reproducible heat defect. In this work, we determine the suitability of an SLA 3D-printed vessel for water calorimetry by investigating the heat defect associated with the vessel, both with and without polymer coating. This will be done by performing calorimeter measurements using our in house built portable water calorimeter with 3D-printed vessels and comparing the dose measured against reference dose measured by an ionization chamber with a calibration coefficient directly traceable to a primary standards laboratory.

Thus, plastic vessels, or more specifically 3D-printed vessels that can be produced rapidly and with high precision and reproducibility which are further coated internally for use in water calorimetry applications, are studied and their stability and associated heat defect correction (k_{hd}) are characterized. This vessel production technique allows for cost-effective rapid construction of vessels that can be produced with high accuracy and complex designs that are simply not practical with current glass vessel construction techniques. This in turn enables water calorimetry applications in many novel radiation delivery modalities, such as spherical vessels in GammaKnife® ICON™ water calorimetry as an example.

### Methods

### Water Calorimetry Principles

In water calorimetry, the absolute dose to water at a point D_{w}(\vec{r}) is directly determined through a measurement of the milli-kelvin radiation-induced temperature rise ΔT(\vec{r}) as shown below:

$${D}_{w} ( \vec{r} ) = {c}_{w , p} \cdot Δ T ( \vec{r} ) \cdot {k}_{h d} \cdot {k}_{h t} \cdot {k}_{p} \cdot {k}_{ρ} \cdot {k}_{d d} , \qquad ( 1 )$$

where c_{w,p} is the specific heat capacity of water at a constant pressure, and the correction factors associated with water calorimetry are denoted by k; these are discussed below:

The heat defect correction k_{hd} accounts for heat loss/gain due to potential endo/exothermic reactions that are facilitated by radiation and occur when trace concentrations of impurities in water interact with resulting free radicals; it can be described by

$${k}_{h d} = \frac{1}{1 - h} , \qquad ( 2 )$$

where h is the heat defect and represents the amount of excess heat generated. As previously discussed, to control heat defect, the temperature sensors are embedded inside an inert glass vessel and filled with high-purity water that is then further saturated with a known high-purity gas for which the heat defect has been well studied and characterized (refs. 2, 3). Heat transfer, including conduction and convection, can influence a calorimeter's response, as the temperature at the measurement point may be affected due to these processes. Not only can radiation-induced thermal distributions in water affect the initial thermal equilibrium and result in heat transfer, but the presence of non-water materials such as the vessel near the point of measurement can also lead to additional thermal non-uniformities. The latter occurs because of potential differences between specific heat capacity of the non-water component and that of water. A heat transfer correction factor kₕₜ accounts for such conductive/convective heat flows and corrects the thermal signal for any potential heat loss/gain as a result. This correction is commonly determined through Finite Element Method (FEM) analysis. In FEM analysis, the calorimeter and the heat source (e.g., radiation beam) are accurately modeled and the thermal response of the calorimeter is evaluated. To further reduce heat transfer effects and simplify their FEM modelling, calorimeters are routinely operated at or near 4° C., where the effects of convection are nearly eliminated due to liquid water properties, i.e., its highest density and lowest volumetric expansion coefficient at this temperature. As such, water calorimeters must be thermally insulated from the environment and commonly have active thermal control.

Perturbation correction factor kₚ corrects for any radiation perturbation as a result of non-water materials present in the beam path, e.g., the vessel. This correction factor can be determined through relative measurements or Monte Carlo simulations. In both methods, dose in a water phantom with and without the non-water materials present is compared.

Ionization chamber measurements are made at room temperature (˜20° C.) while water calorimetry measurements are performed at 4° C. The density correction (kₚ) corrects for differences in depth due to density at room temperature vs calorimeter temperature. The dose profile correction (k_{dd}) corrects for the difference in dose at the point of measurement to the central axis of the beam. This correction is typically applied because temperature changes are commonly measured using two thermistors which are positioned symmetrically approximately 1 mm-2 mm away from the central axis.

### 3D Printed Vessel and Coating

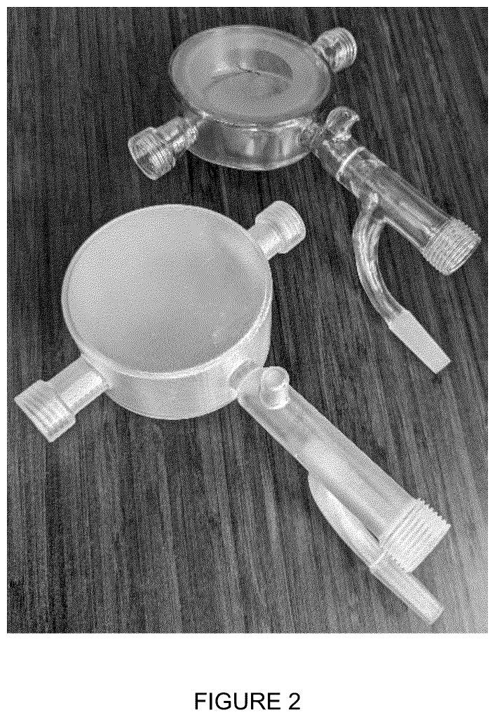

In this study, a Projet 7000 SLA printer was used. This printer uses UV-sensitive liquid resin and a UV laser to produce artifacts. A build platform is submerged into a vat of resin, after which the UV laser traces a pattern on its surface, causing the resin to solidify in the desired pattern. The build platform is then moved down, and the process is repeated layer by layer until the entire artifact is printed. The resin used was Accura ClearVue™. It was chosen as the final 3D-printed part would have a density similar to water (1.17 g/cm³) and is translucent. A vessel designed to resemble our existing glass vessel was created using AutoCAD® software and prepared for printing using 3D Systems 3D Sprint® slicing software with ultra-high-definition print parameters resulting in a slice thickness of 0.10 mm (FIG. 2). A total of eight vessels were printed.

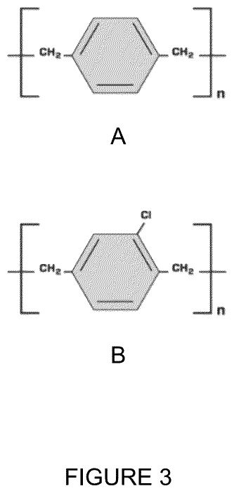

Parylene C™ and Parylene N™ (for which the generic name is poly (para-Xylylene) were chosen as coating materials with their respective structures shown in FIG. 3. Parylene C and N are popular polymer coatings that are commonly used to waterproof electronics and medical devices. In addition, coatings are applied using chemical vapor deposition helping ensure that all surfaces are uniformly coated with a thickness ranging from 1 μm to 10 μm. Both Parylene C and N consist of a repeating para-xylene backbone structure, with a chlorine substituted on the ring for Parylene C (FIG. 3). In this study, a Labcotor® 3 PDS2010 (Specialty Coating Systems) was used to perform chemical vapor deposition. Two vessels were coated using Parylene C and four were coated using Parylene N.

### Calorimeter Preparation and Measurement

Each vessel used in our experiment was prepared the same way prior to measurements: Initially, two calibrated thermistors were accurately positioned inside the vessel to be used. Following this, the vessel was filled with high-purity water (impurities <5 PPB) from a Milli-Q177 UV system. Any dissolved gases in the water were removed by saturating it with high-purity hydrogen gas (impurities <10 PPM) over a period of three hours. To eliminate remaining trace amounts of impurities in water, the vessels were pre-radiated with a minimum dose of 30 Gy. The positions of the thermistors inside the vessel were determined using a Phillips CT simulator. The vessel was then placed inside the calorimeter and the distance from the top surface of the vessel to the top of the calorimeter was measured using calipers. The water calorimeter tank in this work was built in-house and is described in detail in D'Souza et al. (ref. 11). After sealing the water calorimeter tank, it was allowed to cool and stabilize in the lab at 4° C. over a span of several days. All measurements took place in an Elekta Versa HD linear accelerator. Given the calorimeter design, on the day of the measurement, the water calorimeter was wheeled from the lab to the treatment bunker and was positioned using onboard calibrated CBCT imaging.

Measurements were conducted with two uncoated Accura ClearVue™ vessels under a 6 MV Flattening-Filter Free (FFF) beam. Measurements consisted of irradiating the water calorimeter phantom with a field size of 10×10 cm² and a dose rate of 1200 MU/min for 20 seconds. We performed similar measurements with two Parylene C and four Parylene N coated vessels under identical setup conditions as above. These measurements were performed for both the 6 MV FFF beam and an 18 MV beam. Given the 18 MV beam has a dose rate of 600 MU/min, an irradiation period of 40 seconds was used.

To evaluate the stability of Parylene-coated vessels as a function of accumulated time and dose, we sealed one of the Parylene N-coated vessels inside our actively cooled calorimeter for 17 days. We performed measurements on the 3rd, 10th, and 17th days of this period. On the 8th and 15th days, we also delivered a dose of 450 Gy. To evaluate reproducibility, we repeated measurements with three separately constructed and coated Parylene N vessels, where the calorimeter was unsealed and the water inside the vessel replaced, re-saturated with gas, and placed inside the calorimeter to evaluate reproducibility. Prior to performing each calorimeter measurement, an NE 2571 ionization chamber was placed inside a block of solid water and attached to the collimator head using a robust in-house built jig, with sub-mm positioning reproducibility, to measure linac output. In this way, daily fluctuations of linac output were tracked and accounted for in our measurements.

In this study, the heat transfer correction was determined using FEM software COMSOL® Multiphysics v 6.1 where the calorimeter and its components were accurately modeled using a 3D-quarter geometry. The perturbation correction factor was determined using Monte Carlo methods (GEANT4 10.3). The density and dose distribution correction factors were determined by scaling the dose using dose distributions that were measured during annual QA of the Elekta Versa used (ref. 11).

### Ion Chamber Reference Dosimetry

An Exradin A1SL ionization chamber paired with a PTW Unidos E Electrometer with a calibration factor directly traceable to the National Research Council of Canada's primary standard laboratory was used in this study. Using an in-house built adapter, the ionization chamber was placed directly inside the water calorimeter such that the centroid of the chamber was positioned as closely as possible to where the midpoint of the thermistors would be located. The calorimeter was then filled with room temperature water, sealed, and placed under the same conditions as previous caloric measurements. The ionization chamber was warmed up with 1500 MU under a 6 MV FFF beam such that leakage was less than 0.1% of the total measurement signal. Reference dose to water was obtained for a 6 MV FFF beam and an 18 MV beam following procedures outlined in AAPMs TG 51 and its photon addendum (refs. 14, 15).

Heat defect k_{hd} for a given 3D-printed plastic vessel was determined by taking the ratio of the TG-51 reference dose to water measured by the traceable ionization chamber and the dose measured by the water calorimeter that was corrected by all correction factors except heat defect. This can be written as in Equation 3 in the form as:

$${k}_{h d} = \frac{{M}_{raw} \cdot {N}_{D , w}^{{60}_{Co}} \cdot {k}_{Q} {\prod }_{i} {P}_{i}}{{c}_{w , p} \cdot Δ T ( \vec{r} ) \cdot {\prod }_{i} {k}_{i}} , \qquad ( 3 )$$

where the numerator is the ionization chamber reference dose as defined by TG-51 and its photon addendum, with M_{raw} being the raw ionization chamber reading, N_{D,w}⁶⁰^{_{Co}} being the absorbed dose to water calibration factor, k_{Q} being the TG-51 defined beam quality conversion factor, and ΠᵢPᵢ being the product of the ionization chamber correction factors (polarity Pₚₒₗ, ion recombination Pᵢₒₙ, radial profile Pᵣₚ, and temperature/pressure P_{TP}). The exact definition of these parameters is not reproduced in this work to maintain clarity given they are clearly defined in the AAPM TG-51 and its photon addendum (Refs. 14, 15). The denominator in the Equation 3 above is the dose measured by the water calorimeter as defined by Equation 1, where Πᵢkᵢ represents the product of all water calorimetry correction factors except heat defect k_{hd}.

### Electron Microscopy

To evaluate the integrity and uniformity of Parylene coating, the interior of an uncoated Accura ClearVue vessel as well as a Parylene N coated vessel that was used in several of our measurements were studied using electron microscopy. To that end, a 4 mm×12 mm sample from the top surface of each of the vessels was cut. The sample was imaged with a Talos L120C transmission electron microscope (Thermo Scientific) at an accelerating voltage of 120 kV. The sample was examined at magnifications of 1250× and 5300× resulting in a field of view of 43.3 um down to 11.0 μm. The thickness of the coating on the Parylene N coated vessel was then measured.

### Results

### Heat Defect Results

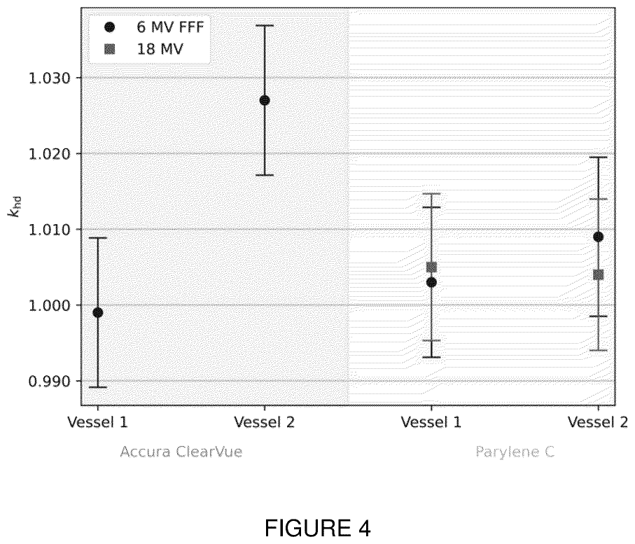

Table 1 shows the calculated water calorimetry correction factors used in this study. We have excluded the heat defect correction of a hydrogen-saturated system (specifically 1.000±0.002 for a glass vessel) since we are investigating this factor for plastic vessels. FIG. 4 shows the heat defect for the uncoated Accura ClearVue and Parylene C vessels. Observing this figure, it can be seen that the heat defect of the two Accura ClearVue vessels under the same 6 MV FFF beam differ by 2.8% (i.e., k_{hd}=0.998±0.010 and 1.026±0.010). When the vessels are coated with Parylene C, it can be seen that k_{hd} is stable across different vessels. It can also be seen that k_{hd} for both 6 MV FFF and 18 MV agree with each other within uncertainties. After combining the 2 Parylene C vessels, an overall k_{hd} of 1.005±0.010 was obtained.

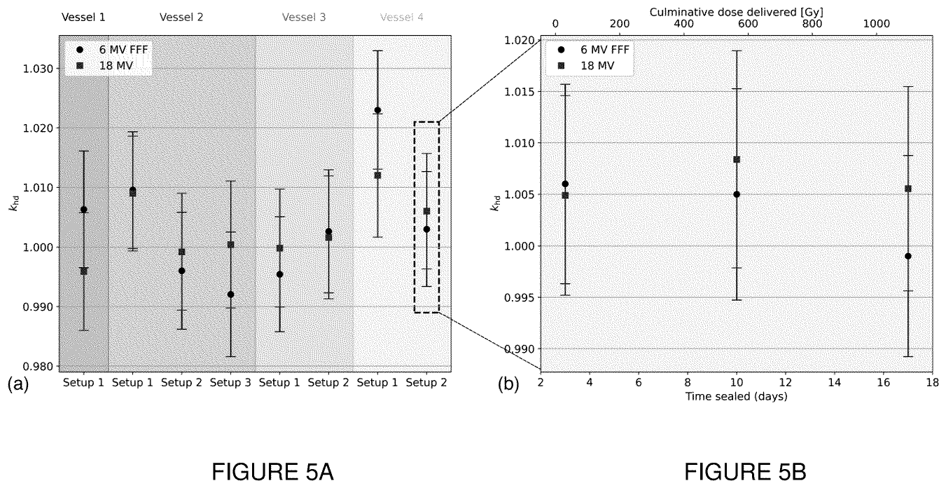

FIGS. 5A and 5B shows the heat defect associated with the Parylene N vessels which yields similar results to a Parylene C vessel (FIG. 5A) single vessel (vessel 4, setup 1) did not initially agree with the expected heat defect results showcasing excess exothermicity; however, after repeating the setup, the response agreed with the general average of the results. The long-term study of a Parylene N coated vessel (FIG. 5B) indicated that the heat defect associated with the vessel is stable as a function of time and accumulated dose. After combining all Parylene N measurements (excluding vessel 4, setup 1) an overall k_{hd} of 1.001±0.010 was achieved.

TABLE 1
Calculated water calorimetry correction factors. For our
experimental setup, only the heat transfer correction
displayed an energy dependence. The number in brackets
represents the k = 1 uncertainty on the last digit

| Correction | Value |
|---|---|
| kₕₜ (6 MV FFF / 18 MV) | 1.000(2) / 1.001(2) |
| kₚ | 1.000(2) |
| k_{ρ} | 1.001(1) |
| k_{dd} | 1.000(1) |

### Uncertainty Budget

Table 2 shows the uncertainty budget analysis associated with our calorimeter measurements. The standard deviation of the mean ranged from 0.17% to 0.50% across measurements. High standard deviations of the mean were due to the limited number of calorimetric runs collected for a given measurement set. Various sources on the list and their associated uncertainties have been described in our previous works and were determined in the same way (refs. 10, 11). Vessel positioning refers to the uncertainty of the vessel depth within the calorimeter that was measured using a vernier caliper. Image positioning is the combined uncertainty associated with the use of a Phillips CT simulator to determine thermistor position inside the vessel, and the use of an onboard CBCT system for final positioning of the thermistors within the water calorimeter at the linac radiation isocenter. The ‘linac output measurement’ uncertainty is included because all calorimeter measurements were normalized to an output constancy readout from an external ion-chamber based jig.

Table 3 showcases the uncertainty budget for our chamber measurements.

Uncertainties were estimated following methodology described by the AAPM TG-51 addendum (ref. 15). The chamber positioning uncertainty refers to the uncertainty associated with measuring chamber depth within the calorimeter using vernier calipers. The imaging uncertainty takes into account the uncertainty of water calorimeter positioning inside the linac using CBCT imaging. Similar to our water calorimeter uncertainty budget, an output uncertainty was included to account for the constancy measurements using the external ion-chamber based jig. Although there may be small correlations between few sources of uncertainty in Tables 2 and 3 given for example both thermistor and chamber positioning was done using CBCT, and same jig was used for constancy measurement in all cases, etc. in this work we ignore all covariance terms for simplicity. As such, the overall uncertainty associated with the heat defect correction factor for each measurement was determined by combining both chamber and calorimeter uncertainties in quadrature resulting in a very conservative k=1 uncertainty ranging between 0.96% to 1.07%.

TABLE 2
Uncertainty budget for calorimeter measurements

| Name | Type A (%) | Type B (%) |
|---|---|---|
| Std deviation of the mean^{a} | 0.17-0.50 | |
| kₕₜ | | 0.18 |
| kₚ | | 0.20 |
| k_{ρ} | | 0.05 |
| k_{dd} | | 0.05 |
| c_{w,p} | | 0.05 |
| Vessel positioning | 0.12 | |
| Image positioning | | 0.31 |
| Thermistor calibration | | 0.10 |
| Bridge calibration | | 0.14 |
| Temperature measurement | | 0.23 |
| Linac output Measurement | | 0.09 |

| | |
|---|---|
| Combined uncertainty (k = 1) | 0.55-0.73 |

^{a}The range of standard deviation of the means across all calorimeter measurements is presented here

TABLE 3
Uncertainty budget for ionization chamber measurements

| Name | Type A (%) | Type B (%) |
|---|---|---|
| Std deviation of the mean | 0.01 | |
| Pₚₒₗ | | 0.05 |
| Pᵢₒₙ | | 0.10 |
| Pᵣₚ | | 0.05 |
| P_{TP} | | 0.05 |
| N_{D, w}^{60 Co} | | 0.50 |
| Chamber positioning | 0.12 | |
| Image positioning | | 0.24 |
| k_{Q} | | 0.50 |
| Assignment of k_{Q} | | 0.10 |
| Linac output measurement | | 0.09 |

| | |
|---|---|
| Combined uncertainty (k = 1) | 0.78 |

### Electron Microscopy

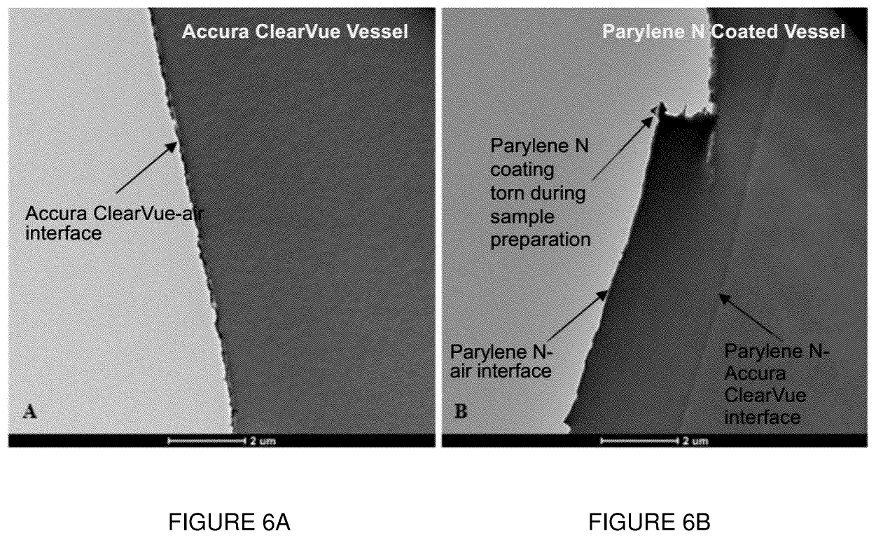

FIGS. 6A and 6B show a 5300× magnification image of an uncoated Accura ClearVue vessel and a Parylene N coated vessel (vessel 3 as referred to in FIGS. 5A and 5B) respectively. Comparing the two images, it can be seen that the Parylene N coated vessel has an approximately 3 μm 321 thick coating. In the top portion of FIG. 6B, part of the coating is torn likely during the sample preparation step when initial cuts are made to separate the sample from the vessel. The surface of the vessel is also completely covered, indicating that there are no gaps in coating.

### Discussion

Based on the results disclosed herein, an uncoated 3D-printed plastic vessel is not suitable for water calorimetry due to a vessel-dependent heat defect. Coating the vessel with Parylenes theoretically avoids leaching chemicals from the vessel. Here, the hydrophobic coating is in contact with water directly, and any leachate will be from the coating itself resulting in consistent reactions as long as the surface of the vessel is completely covered. Our results showcase this effect. When coating different plastic vessels with Parylene C or Parylene N, we were able to produce a mostly stable heat defect across vessels that would otherwise show large variations in heat defects. The coated vessels (barring a single Parylene N vessel setup) also agreed with the heat defect correction associated with a hydrogen-saturated glass vessel system (1.000±0.002) (ref. 16). TEM images of the vessel also showed that the coating was intact after irradiation and that chemical vapor deposition of Parylenes uniformly covered all inner surfaces.

FIG. 5A shows a large discrepancy between the results of the 4th vessel in its initial setup; however, this excess exothermicity could not be reproduced when we repeated the measurement setup as the results for both energies agreed with the overall mean. This possibly indicates an issue with the vessel preparation step. As such, the data from this setup was excluded from the calculations used to estimate the average overall heat defect correction factor. It should be noted that the heat defect correction is known to change as a function of linear energy transfer (LET) due to different yields of free radicals (refs. 17, 18). In this study we were limited to only high energy photon beams that have a similar low LET. Our results show relatively energy independent And as expected. Further studies are needed to investigate how the system responds under different LET beams. The uncertainty on heat defect measurement in our work combined both uncertainties from ionization chamber and water calorimetry dosimetry, and as such was quite high with a magnitude of 1.01% (k=1).

In conclusion, our results suggest that a 3D-printed vessel coated with Parylene can be effectively used in water calorimetry. This approach allows for the creation of unique vessel shapes and designs for water calorimetry that may not be feasible to construct with glass, at a fraction of the cost and time to what it normally takes to construct glass vessels. A 3D-printed vessel can also be constructed at a much higher precision compared to a glass vessel. Given the similarity in physical properties of plastics to water, a 3D-printed vessel perturbs the radiation beam much less than its glass counterpart, resulting in a smaller perturbation correction. Moreover, due to thermal properties of Accura ClearVue and the closer match between specific heat capacity of Accura ClearVue (1318 J kg⁻¹ K⁻¹) and water (4207.5 J kg⁻¹ K⁻¹) compared to that of glass (800 J kg⁻¹ K⁻¹) and water, a smaller heat transfer correction is needed for Accura ClearVue vessels compared to glass vessels for a given measurement condition (refs. 19-21).

A 3D-printed and coated vessel as disclosed herein paves the way for novel applications of water calorimetry to modern radiotherapy delivery technologies such as GammaKnife® ICON as it enables production of spherical vessels or other optimized shapes/designs. While Accura ClearVue was chosen for this study, we are investigating other 3D-printing materials including glass and metal as well as other machining methods to determine any potential advantages. We are also conducting further studies to determine if other coating materials/technologies may be beneficial.

In conclusion, the heat defect associated with 3D-printed vessels and Parylene coated vessels was studied. Coating vessels with Parylene results in a stable heat defect across all vessels as a function of energy (6 MV FFF and 18 MV), time (17 days), and accumulated dose (1100 Gy). The overall heat defect correction for Parylene C and Parylene N coated vessels was determined to be 1.005±0.010 and 1.001±0.010 respectively.

The inventors have shown that a 3D-printed coated vessel can be used for water calorimetry instead of a traditional glass vessel. 3D printing allows for sub-millimeter precision, enabling the crafting of vessels with highly accurate dimensions, including those with unique and intricate shapes. These vessels can be constructed quickly, within a matter of hours, in a manner that is both cost-effective (CAD $100) and efficient. Moreover, the production process is easily scalable. This stands in sharp contrast to the production of currently used glass vessels.

Materials used for 3D printing are often chemically complex. If they leach into water they can result in an unstable heat defect. However, the present surfaces of the present 3D printed vessels have been coated. While use of polymer coatings has been disclosed herein, it will be clear to those skilled in the art that other types of stable coatings may be used. By surface coating, the potential for chemical molecules from the vessel to leach into water is significantly reduced if not completely eliminated. This coating innovation can be tailored to minimize reactions with radicals produced by ionizing radiation, making it a strategic solution that complements the advantages of 3D printing.

The 3D-printed and coated vessels for water calorimetry disclosed herein are very advantageous for direct use in radiotherapy clinics and represents a significant advancement in the field of dosimetry. By incorporating a water calorimeter-based dosimeter in clinics with a coated vessel, several distinct benefits are achieved. First and foremost, the accuracy and precision of dose measurements could be improved by reducing the uncertainty from several percents to close to 1% for measurements of absolute dose to water. Secondly and perhaps more importantly, this dosimeter would serve as the ultimate universal detector, capable of handling all beam types, energies, and modalities, and remaining unaffected by ambient conditions, such as the magnetic field found in MR-integrated linacs.

An important field of study that 3D printing of vessels opens up is the potential to 3D print extremely thin thermal barriers within the vessel. Traditional water calorimeters are often operated at 4° C. to minimize convection. However, by directly 3D printing convective thermal barriers within the vessel (and the calorimeter tank), the possibility of much simpler room temperature operated water calorimeters becomes a reality. The inventors and associates have already begun performing numerical simulations to design such calorimeters.

The vessels for water calorimetry disclosed herein are very advantageous in respect of their adaptability. For example, water calorimeters that can be made much cheaper with designs that accommodate many of the novel radiation modality techniques is very advantageous and useful. These could be used by metrology labs or other accredited labs to calibrate user detectors under beams of interest, eliminating the need for complex protocols requiring correction factors that in turn would add to the final uncertainty. To second order, water calorimeter detectors (especially those that can be operated at room temperature) can be used in clinics, minimizing user error, and improving both dose measurement accuracy and patient safety at the same time.

While the present disclosure has been illustrated using a 3D printed vessel in which the polymer resin used was Accura ClearVue™ with the printed vessel then coated with Parylene C or Parylene N using chemical vapor deposition, it will be appreciated that these are only non-limiting examples. Given the innovation to allow non-glass vessel materials be used for water calorimetry through the process of surface coating, vapor deposition, etc., it will be evident to those skilled in the art that different or more complex vessel design/shapes could be considered. As such, parallel-plate (pancake shape) vessel as shown in this disclosure is just one option. Other vessel designs such as cylindrical, spherical, cubic, or other non uniform shapes may be used.

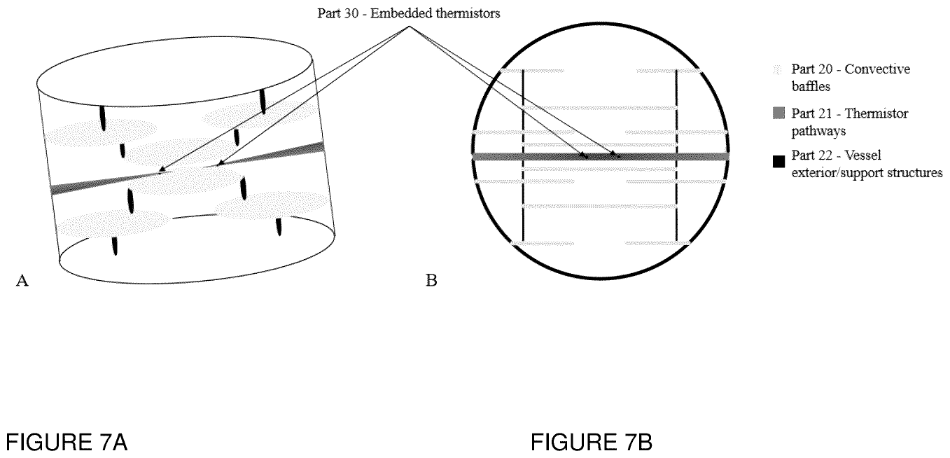

Vessels could in turn contain internal structures, convective barriers, or baffles as shown in FIG. 7A and FIG. 7B. These two FIGURES show two (2) of the many non-limiting alternative vessel designs options possible. In these images part 20 represents convective baffles and part 21 represents 3D printed pathways for thermistor placement. Part number 22 represents the exterior of the vessel or support structures FIG. 7A displays a 3D rendering of a plane parallel vessel while FIG. 7B showcases a 2D cross sectional images of a spherical vessel. In both designs pathways exist for at least two thermistors (part 30) to be placed. These designs could be extended to include more thermistors and convective baffles. For brachytherapy applications an internal pathway for radioactive source transport can be included.

Vessels could also be embodied in other structures that may reduce convective currents around the vessel. It will be clear to those skilled in the art that the construction method or materials used to produce the vessel have minimal consequence given the coating material in conjunction with gas saturation dominates the ultimate vessel performance. As such, the vessel material has little bearing using this coating technology: the vessel could be manufactured using conventional or modern machining technologies from acrylic, polyethylene, vinyl, polystyrene, nylon, graphite, aluminum, other metals or alloys, delrin, other polymers or ceramics, or it could be 3D printed using stereolithography (SLA), selective laser sintering (SLS), multi jet fusion (MJF), polyjet, focused deposition modeling (FDM), digital light process (DLP), direct metal laser sintering (DMLS), or electron beam melting (EBM) using materials such as polylactic acid (PLA), acrylonitrile butadiene styrene (ABS), nylon, polyethylene terephthalate glycol (PETG), Acura ClearView, other standard SLA resins, clear resins, draft resins, etc. Glass 3D printing could also be utilized.

The polymer of which the vessel is made can be any one of acrylic, polyethylene, vinyl, polystyrene, nylon or Delrin. The water calorimeter vessel may be made from aerogel or aerogel-based materials. The aerogel or aerogel-based material may be based on silica, which is the most common material used to make aerogel. Silica aerogel is only three times heavier than air. The aerogel may be made from other materials, for example, but not limited to, carbon, iron oxide, organic polymers, copper, gold, and semiconductor nanostructures. Aerogels are among the lightest known materials having densities in a range from about 0.0011 to about 0.5 grams/cm³.

Alternatively, the vessel could be produced using a combination of the aforementioned techniques and materials, or be produced in parts that are then attached to each other during the final construction.

The coating could be applied through physical vapor deposition (PVD) or other surface deposition techniques using Parylene N, C, D, HT, AF-4, F, titanium, gold, aluminum or copper. Alternatively, plating on various plastics and plastic resins may be used. The coating may be applied once or multiple times to the vessel and its embodiments. Several coatings can be applied in one session or various sessions.

The vessels may contain one or more thermistors for measurement of temperature changes during irradiation. These thermistors could either be themselves positioned inside glass tubing or other insulating materials. Alternatively, insulated thermistors could be directly placed inside the vessel, or instead, thermistors could be positioned inside the vessel and be coated along with the vessel resulting in their insulation. The thermistors can be calibrated prior to placement inside the vessel or following placement using common calibration techniques such as being immersed inside a computer-controlled variable temperature water bath where calibration uncertainties of 0.2-0.3% are achieved. As will be evident to those skilled in the art, the vessel and all internal structures including thermistors must be cleaned prior to assembly. The vessel is filled with high purity water, and then saturated with high purity gas. Various gases including H₂, Ar, N₂, O₂, N₂O, CO, formate and others have been used in the past.

The vessel may be reusable whereby the thermistors and/or the water inside could be removed and replaced at a later time. This requires ports of entry for thermistors and/or water as well as for gas saturation. These ports are sealed upon preparation of the vessel, but could be unsealed for exchange of thermistors/water. Alternatively, the vessel could be permanently sealed following initial preparation.

### EMBODIMENTS

In an embodiment there is disclosed a water calorimeter vessel, comprising a vessel having a preselected size, shape and internal volume enclosed by an inner wall, the vessel being at least partially transparent to radiation. The vessel has one or more layers coated on the internal wall of the vessel with the layer(s) selected on the basis of being able to block impurities/leachants diffusing from material from which the vessel is made and from the layer(s) into the interior of the vessel. One or more temperature sensors are located on the interior of the vessel and connected to a temperature recording device.

In an embodiment the one or more layers coated on the internal wall is/are an organic material or an inorganic material.

In an embodiment the organic material is any one or combination of Parylene N, Parylene C, Parylene D, Parylene HT, Parylene F, Parylene AF-4 and urethane.

In an embodiment the inorganic material is any one or combination of titanium, silicon, gold, aluminum, copper and glass.

In an embodiment the vessel contains internal structures and positioned in the interior to act as convective barriers, or baffles to reduce convective current around the interior of the vessel.

In an embodiment the vessel is made from any one of a polymer, graphite, aluminum, other metals or alloys, ceramics, aerogel or aerogel-based materials, synthetic materials or and composites.

In an embodiment the vessel is made from a polymer.

In an embodiment the polymer is any one of acrylic, polyethylene, vinyl, polystyrene, nylon or Delrin.

In an embodiment the vessel is 3D printed using a resin of the polymer.

In an embodiment vessel is made from an aerogel material.

In an embodiment the aerogel has a density in a range from about 0.0011 to about 0.5 grams/cm³.

In an embodiment the one or more layers coating the internal surface of the vessel has a thickness greater than about 1 micrometer.

In an embodiment a vessel surface through which radiation passes has a thickness in a range from about 0.20 to about 10.0 millimeters.

In an embodiment the vessel contains internal structures and positioned in the interior to act as convective barriers, or baffles to reduce convective current around the interior of the vessel.

In an embodiment the vessel is made from any one of a polymer, graphite, aluminum, other metals or alloys, ceramics, aerogel or aerogel-based materials, synthetic materials and composites.

In an embodiment the vessel is made from a polymer.

In an embodiment the one or more layers coating the internal surface of the vessel has a thickness greater than about 1 micrometer.

In an embodiment a vessel surface through which radiation passes has a thickness in a range from about 0.20 to about 3.0 millimeters.

### REFERENCES

1. Seuntjens J, Thierens H, Schneider U. Correction factors for a cylindrical ionization chamber used in medium-energy X-ray beams. Phys Med Biol. 1993; 38 (6): 805-832. doi:10.1088/0031-9155/38/6/013
2. Klassen N V., Ross C K. Water calorimetry: The heat defect. J Res Natl Inst Stand Technol. 1997; 102 (1): 63-74. doi:10.6028/jres. 102.006
3. Ross C K, Klassen N V., Smith G D. The effect of various dissolved gases on the heat defect of water. Med Phys. 1984; 11 (5): 653-658. doi:10.1118/1.595547
4. Sarfehnia A, Kawrakow I, Seuntjens J. Direct measurement of absorbed dose to water in HDR 192 Ir brachytherapy: Water calorimetry, ionization chamber, Gafchromic film, and TG-43. Med Phys. 2010; 37 (4): 1924-1932. doi:10.1118/1.3352685
5. Sarfehnia A, Seuntjens J. Development of a water calorimetry-based standard for absorbed dose to water in HDR 192Ir brachytherapy. Med Phys. 2010; 37 (4): 1914-1923. doi:10.1118/1.3366254
6. Renaud J, Sarfehnia A, Marchant K, McEwen M, Ross C, Seuntjens J. Direct measurement of electron beam quality conversion factors using water calorimetry. Med Phys. 2015; 42 (11): 6357-6368. doi:10.1118/1.4931970
7. Renaud J, Rossomme S, Sarfehnia A, et al. Development and application of a water calorimeter for the absolute dosimetry of short-range particle beams. Phys Med Biol. 2016; 61 (18): 6602-6619. doi:10.1088/0031-9155/61/18/6602
8. Sarfehnia A, Clasie B, Chung E, et al. Direct absorbed dose to water determination based on water calorimetry in scanning proton beam delivery. Med Phys. 2010; 37 (7): 3541-3550. doi:10.1118/1.3427317
9. Rossomme S, Renaud J, Lee N, et al. SU-E-T-408: Determination of KQ, Q0-Factors From Water and Graphite calorimetry in a 60 MeV Proton Beam. Med Phys. 2014; 41 (6Part17): 319. doi:https://doi.org/10.1118/1.4888741
10. D'Souza M, Nusrat H, Jakovenko V, et al. Water calorimetry in MR-linac: Direct measurement of absorbed dose and determination of chamber kQmag. Med Phys. 2020; 47 (12): 6458-6469. doi:10.1002/mp. 14468
11. D'Souza M, Nusrat H, Renaud J, Peterson G, Sarfehnia A. First-stage validation of a portable imagable MR-compatible water calorimeter. Med Phys. 2020; 47 (10): 5312-5323. doi:10.1002/mp. 14448
12. Sarfehnia A. Water calorimetry-Based Radiation Dosimetry in Iridium-192 Brachytherapy and Proton Therapy. Doctoral Thesis. McGill University; 2010.
13. Specialty Coating Systems. SCS Parylene Properties. Published 2023. Accessed Feb. 4, 2023. https://scscoatings.com/parylene-coatings/parylene-properties
14. Almond P R, Biggs P J, Coursey B M, et al. AAPM's TG-51 protocol for clinical reference dosimetry of high-energy photon and electron beams. Med Phys. 1999; 26 (9): 1847-1870. doi:10.1118/1.598691
15. McEwen M, DeWerd L, Ibbott G, et al. Addendum to the AAPM's TG-51 protocol for clinical reference dosimetry of high-energy photon beams. Med Phys. 2014; 41 (4): 1-20. doi:10.1118/1.4866223
16. Picard S, Burns D T, Roger P, et al. Comparison of the standards for absorbed dose to water of the NRC and the BIPM for accelerator photon beams. Metrologia. 2010; 47:06025. doi:10.1088/0026-1394/47/1a/06025
17. Ross C K, Klassen N V. Water calorimetry for radiation dosimetry. Phys Med Biol. 1996; 41 (1): 1-29. doi:10.1088/0031-9155/41/1/002
18. Elliot A J. Rate Constants and G-Values for the Simulation of the Radiolysis of Light Water over the Range 0-300° C. AECL, Chalk River Nuclear Laboratories. Published online 1994: AECL11073.
19. Yang G, Migone A D, Johnson K W. Heat capacity and thermal diffusivity of a glass sample. Physical Reviews B. 1992; 45.
20. Dhanasegaran R. Experimental and Computational Investigations of Heat Transfer in Aero Engine Outlet Guide Vane (OGV). Masters Thesis. Chalmers University of Technology; 2018.
21. Lemmon E W, McLinden M O, Friend D G. Thermophysical Properties of Fluid Systems. In: Linstorm P J, Mallard W G, eds. NIST Chemistry WebBook, NIST Standard Reference Database Number 69. National Institute of Standards and Technology. doi:https://doi.org/10.18434/T4D303

Therefore what is claimed is:

1. A water calorimeter vessel, comprising:
a vessel having a preselected size, shape and internal volume enclosed by an inner wall, the vessel being at least partially transparent to radiation;
the vessel having one or more layers coated on the internal wall of the vessel, the one or more layers selected on the basis of being able to block impurities/leachants diffusing from material from which the vessel is made and from the one or more layers into the interior of the vessel; and
one or more temperature sensors located on the interior of the vessel and connected to a temperature recording device.

2. The water calorimeter vessel according to claim 1, wherein the one or more layers coated on the internal wall is an organic material or an inorganic material.

3. The water calorimeter vessel according to claim 2, wherein the organic material is any one or combination of Parylene N, Parylene C, Parylene D, Parylene HT, Parylene F, Parylene AF-4 and urethane.

4. The water calorimeter vessel according to claim 2, wherein the inorganic material is any one or combination of titanium, silicon, gold, aluminum, copper, or glass.

5. The water calorimeter vessel according to claim 1, wherein the vessel contains internal structures and positioned in the interior to act as convective barriers, or baffles to reduce convective current around the interior of the vessel.

6. The water calorimeter vessel according to claim 1, wherein the vessel is made from any one of a polymer, graphite, aluminum, other metals or alloys, ceramics, aerogel or aerogel-based materials, synthetic materials and composites.

7. The water calorimeter vessel according to claim 1, wherein the vessel is made from a polymer.

8. The water calorimeter vessel according to claim 7, wherein the polymer is any one of acrylic, polyethylene, vinyl, polystyrene, nylon or Delrin.

9. The water calorimeter vessel according to claim 7, wherein the vessel is 3D printed using a resin of the polymer.

10. The water calorimeter vessel according to claim 1, wherein the vessel is made from an aerogel material.

11. The water calorimeter vessel according to claim 10, wherein the aerogel has a density in a range from about 0.0011 to about 0.5 grams/cm³.

12. The water calorimeter vessel according to claim 1, wherein the one or more layers coating the internal surface of the vessel has a thickness greater than about 1 micrometer.

13. The water calorimeter vessel according to claim 1, wherein a vessel surface through which radiation passes has a thickness in a range from about 0.20 to about 10.0 millimeters.

14. The water calorimeter vessel according to claim 2, wherein the vessel contains internal structures and positioned in the interior to act as convective barriers, or baffles to reduce convective current around the interior of the vessel.

15. The water calorimeter vessel according to claim 1, wherein the vessel is made from any one of a polymer, graphite, aluminum, other metals or alloys, ceramics, aerogel or aerogel-based materials, synthetic materials and composites.

16. The water calorimeter vessel according to claim 2, wherein the vessel is made from a polymer.

17. The water calorimeter vessel according to claim 2, wherein the one or more layers coating the internal surface of the vessel has a thickness greater than about 1 micrometer.

18. The water calorimeter vessel according to claim 2, wherein a vessel surface through which radiation passes has a thickness in a range from about 0.20 to about 3.0 millimeters.
